(19) United States
(12) Patent Application Publication
(10) Pub. No.: US 2021/0078135 A1
(43) Pub. Date: Mar. 18, 2021

(54) ROTATIONAL SPEED CONTROL IN ROBOT-SUPPORTED GRINDING

(71) Applicant: FerRobotics Compliant Robot Technology GmbH, Linz (AT)

(72) Inventor: Ronald Naderer, Oberneukirchen (AT)

(21) Appl. No.: 16/980,958

(22) PCT Filed: Mar. 13, 2019
(86) PCT No.: PCT/EP2019/056300

§ 371 Date: Oct. 15, 2020

(30) Foreign Application Priority Data
Mar. 15, 2018 (DE) 10 2018 106 086.6

(51) Int. Cl. B24B 51/00; B24B 49/00

(52) U.S. Cl. CPC B24B 51/00; B25J 11/0065; B24B 49/006

(57) ABSTRACT

The invention relates to a method for the automated grinding of surfaces and to a corresponding device. According to one exemplary embodiment, the method comprises the robot-assisted positioning of a grinding machine with a grinding tool, so that the grinding tool contacts the surface when the grinding machine is operated at a first rotational speed, and the detection of the contact between the grinding tool and the surface. The method further comprises, as a result of detecting the contact, the increase in the rotational speed of the grinding tool from the first rotational speed to a second rotational speed.

### TECHNICAL FIELD

The present disclosure relates to a grinding machine for robot-supported grinding, as well as to a robot-supported method for grinding the surfaces of work pieces.

### BACKGROUND

In robot-supported grinding apparatuses, a grinding machine (e.g. an electrically driven grinding machine with a rotating grinding disc as a grinding tool) is guided by a manipulator, for example, an industrial robot. When doing so, the grinding machine can be coupled in various ways to the so-called tool center point (TCP) of the manipulator, enabling the manipulator to adjust the machine to any desired position and orientation. Industrial robots are generally position-controlled, which makes it possible to move the TCP precisely along an intended trajectory. In order to achieve good results in robot-supported grinding, many application require that the processing force (grinding force) be regulated, which is something that is difficult to realize with satisfying accuracy using conventional industrial robots. The large and heavy arm segments of an industrial robot have too much mass inertia for a controller (closed-loop controller) to be able to react quickly enough to variations in the processing force. To solve this problem, a small in comparison to the industrial robot linear actuator can be arranged between the TCP of the manipulator and the grinding machine that couples the TCP of the manipulator to the grinding machine. In this case the linear actuators only controls the processing force (that is, the contact force applied between the grinding tool/grinding disc and the work piece) while grinding, whereas the manipulator moves the grinding machine, together with the linear actuator (and therewith the grinding tool) position-controlled along a specifiable trajectory.

To machine surfaces, orbital or eccentric grinding machines can be used. When the machining is carried out, the grinding machine is switched on (i.e. the grinding disc is rotating) when the grinding disc comes into contact with the machined surface. In doing so, the problem can arise that scratches or grooves may come about when the machined surface is contacted using the robot. A skilled specialist can avoid such undesired consequences by being particularly careful when applying the grinding machine to the surface, but this is not always possible to a sufficient extent during robot-assisted machining.

The inventors have set themselves the objective of developing an improved grinding apparatus for robot-assisted grinding.

### SUMMARY

The aforementioned objective may be achieved by the grinding apparatus in accordance with the embodiments described herein.

In the following a grinding device for machining a surface will be described. In accordance with one embodiment, the grinding apparatus comprises a grinding machine that is coupled to a manipulator and that has a motor, a grinding tool driven by the motor and a control system. The latter is configured to control the grinding machine by adjusting the rotational speed of the grinding disc, to position the grinding machine with the aid of the manipulator in order to contact the surface with the grinding tool while the grinding machine is being run at a first rotational speed, and to detect a contact between the grinding tool and the surface. In response to the detection of a contact, the rotational speed of the grinding tool is raised from the first rotational speed to a second rotational speed.

Further, a method for the automated grinding of surfaces will be described. In accordance with one embodiment, the method includes the method of robot-supported positioning of a grinding machine having a grinding tool such that the grinding tool contacts the surface while the grinding machine is being driven at a first rotational speed, as well as detecting the contact between the grinding tool and the surface. The method further comprises raising the rotational speed of the grinding tool from the first rotational speed to a second rotational speed in response to the contact detection.

### BRIEF DESCRIPTION OF THE FIGURES

Various embodiments will now be described in greater detail with reference to the examples illustrated in the figures. The illustrations are not necessarily true to scale and the embodiments are not limited to the aspects illustrated here. Instead importance is given to illustrating the underlying principles. The figures show:

FIG. 1 schematically shows an example of a robot-supported grinding apparatus.

FIG. 2 shows, in a diagram, the controlling of the rotational speed of the grinding tool in reaction to detecting a contact between the grinding tool and the work piece.

FIG. 3 shows, in a diagram, the adjustment of the contact force and the controlling of the rotational speed of the grinding tool in reaction to detecting a contact between the grinding tool and the work piece.

FIG. 4 is a flowchart that illustrates an embodiment of a method for robot-supported grinding.

### DETAILED DESCRIPTION

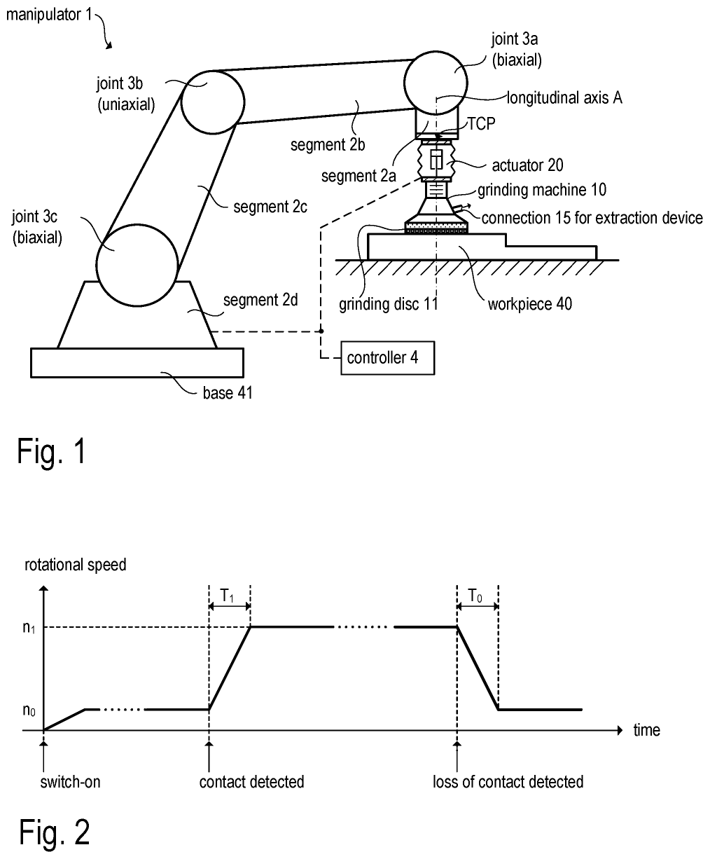

Before describing in detail various embodiments, an example of a robot-supported grinding apparatus will be described first. The apparatus comprises a manipulator 1, for example, an industrial robot, and a grinding machine (10) that has a rotating grinding tool (e.g. an orbital grinding machine), wherein the latter is coupled to the so-called tool center point (TCP) of the manipulator 1 via a linear actuator 20. In the case on an industrial robot that has 6 degrees of freedom, the manipulator can be constructed to comprise 4 segments 2a, 2b, 2c and 2d, each of which is connected via joints 3a, 3b and 3c. The first segment is usually rigidly attached to the base 41 (which, however, need not necessarily be the case). The joint 3c connects the segments 2c and 2d. The joint 3c can be biaxial and thus allow for a rotation of the segment 2c around a horizontal axis of rotation (elevation angle) and around a vertical axis of rotation (azimuth angle). The joint 3b connects the segments 2b and 2c and allows a pivotal movement of the segment 2b relative to the position of the segment 2c. The joint 3a connects the segments 2a and 2b. The joint 3a can be biaxial and can thus (similar to the joint 3c) allow for a pivotal movement in two directions. The TCP is at a permanent position relative to segment 2a, which is usually also has a rotary joint (not shown), allowing for a rotational movement around a longitudinal axis A of the segment 2a (designated in FIG. 1 with a dash-dotted line and which corresponds to the rotational axis of the grinding tool). An actuator is designated for the axis of every joint which can effect a rotational movement around the respective joint axis. The actuators in the joints are driven by the robot controller 4 in accordance with a robot program. Various types of industrial robots/manipulators and their respective controllers are generally known and will therefore not be further detailed here.

The manipulator 1 is generally position-controlled, i.e. the robot controller can determine the pose (position and orientation) of the TCP and can move it along a previously defined trajectory. In FIG. 1, the longitudinal axis of the segment 2a, on which the TCP lies, is designated with A. When the actuator 20 is resting against an end stop, the pose of the TCP also defines the pose of the grinding tool. As previously mentioned, the actuator 20 serves to adjust the contact force (processing force) between the tool and the work piece 40 to a desired value. Adjusting the force directly with the manipulator 1 is generally too imprecise as the high mass inertia of the segments 2a-2c make it virtually impossible for conventional manipulators to quickly compensate variations in the force (e.g. as occur when the grinding tool is placed onto the work piece 40). For this reason the robot controller is configured to adjust the pose (position and orientation) of the TCP of the manipulator 1 while the force regulation is completely carried out by the actuator 20.

As previously mentioned, the contact force F_{K} (also known as the processing force) between the grinding tool and the work piece 40 can be adjusted with the aid of the (linear) actuator 20 and a force controller (which, for example, can be implemented in the robot controller 4) so that the contact force F_{K} (in the direction of the longitudinal axis A) between the grinding tool and the work piece 40 corresponds to a specifiable target value. The contact force in this case is a reaction to the actuator force with which the linear actuator 20 presses against the work piece surface. When there is no contact between the work piece 40 and the tool, as a result of the absence of contact force on the work piece the actuator 20 comes to rest against an end stop (not shown here as it is integrated in the actuator 20) and presses against it with a defined force. In this situation (no contact) the actuator deflection is therefore at maximum and the actuator is in an end position. The position controller of the manipulator 1 (which may also be implemented in the robot controller 4) can operate completely independently of the force controller of the actuator 20. The actuator 20 is not responsible for the positioning of the grinding machine 10, but only for the adjustment and maintenance of the desired contact force F_{K} during the grinding process and for determining when contact between the tool and the work piece takes place. Contact can be easily determined, e.g. by detecting that the actuator has move out of its end position (the actuator deflection is then smaller than the maximum deflection a_{MAX}).

The actuator may be a pneumatic actuator, e.g. a double-acting pneumatic cylinder. Other types of pneumatic actuators, however, may also be used such as, e.g. bellows cylinders and air muscles. As an alternative, electric direct drive (gearless) may also be considered. Here it should be pointed out that the effective direction of the actuator 20 need not necessarily coincide with the longitudinal axis A of segment 2a of the manipulator. In the case of a pneumatic actuator, the force can be adjusted in a well known manner using a control valve, a controller (implemented in the robot controller 4) and a compressed air reservoir. The specifics of the implementation, however, are of little relevance for the further description and will therefore not be discussed in detail. Grinding machines generally have an extraction system for removing the grinding dust. In FIG. 1, a connection 15 for a hose of an extraction device is shown.

The grinding machine 10 usually comprises an electric motor that drives the grinding disc 11. In the case of an orbital grinding machine, the grinding disc 11 is mounted on a back plate which itself is connected to the motor shaft of the electric motor. Asynchronous or synchronous motors can be considered for the electric motor. Synchronous motors have the advantage that the rotational speed does not change together with the load, but only the slip angle, whereas in the case of asynchronous machines the rotational speed falls as the load increases. The load on the motor is in this case essentially proportional to the contact force F_{K} and the friction between the grinding disc 11 and the machined surface of the work piece 40.

The concepts described here can also be applied to grinding machines that have a pneumatic motor (compressed air motor). Grinding machine that operate on compressed air can have a relatively compact construction as compressed air motors generally exhibit a small power-to-weight ratio. Regulating the rotational speed is easy to realize, e.g. by means of a pressure control valve (controlled, for example, by the robot controller 4), additionally or alternatively using a throttle, whereas when synchronous or asynchronous motors are used (e.g. electrically controlled by the robot controller 4), a frequency converter is needed to control the rotational speed.

In order to make the moment of contact between the work piece surface and the grinding disc (i.e. the contacting process) more “gentle”, the motor of the grinding machine 10 can be initially run (before contact) at a first, lower rotational speed no. Once it is at this speed, the manipulator positions the grinding machine above the machined surface and then moves the grinding machine towards the surface until the grinding disc 11 contacts the surface (see FIG. 1). As soon as the controller detects that contact has taken place, the rotational speed of the motor is raised to a second, higher value n₁. After contact is ended (e.g. when the manipulator 1 moves the grinding machine away from the surface), the rotational speed can one again be reduced to the value n₀. This situation is illustrated in FIG. 2.

The rise time T₁ needed for the rotational speed to rise from the value n₀ to the value n₁ is limited (downwardly) by the dynamics of the grinding machine and of the rotational speed controller. This means that, when the rotational speed is abruptly “switched over”, the rise of the rotational speed from n₀ to n₁ takes a defined amount of time. In this case the rotational speed can be raised in a “controlled” manner (by means of the rotational speed controller) within a defined period of time T₁. In the example shown here, the rotational speed is reduced upon loss of contact back to the value n₀ within the time period T₀. This time period is not necessarily of the same length as the rise time T₁ and may be, e.g. longer.

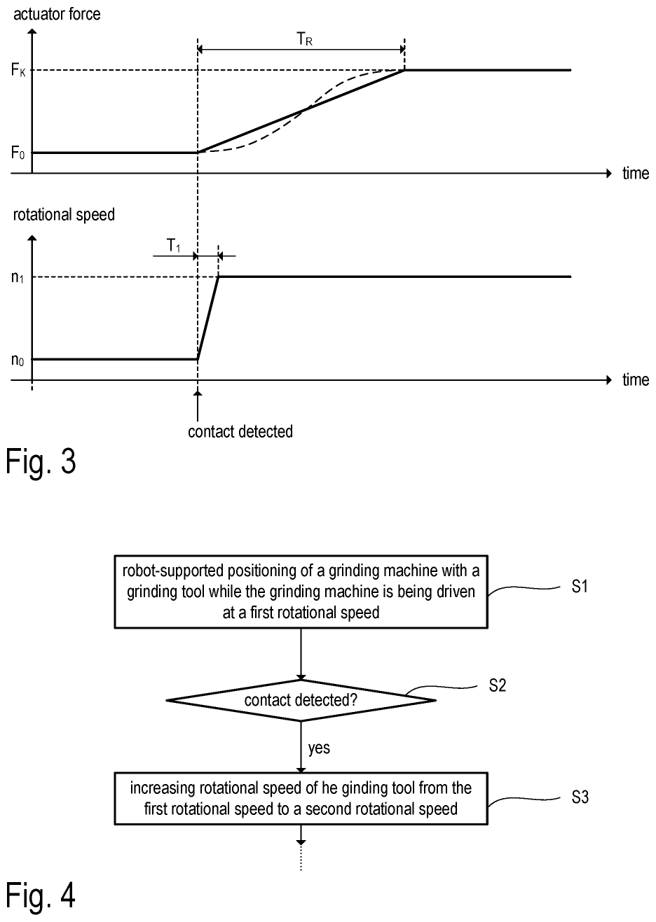

The diagrams in FIG. 3 illustrate an example of when the robot controller 4 not only reacts to the detection of a contact by raising the rotational speed of the grinding disc 11, but also with a controlled raising of the actuator force (the force exerted by the actuator onto the surface), beginning from an adjustable minimal force F₀ and ending at the desired contact force F_{K}. In accordance with one embodiment, the actuator force is raised within a defined period of time T_{R}. This rise of the actuator force may be linear, but this need not necessarily be the case. The dashed line shown in the first diagram of FIG. 3 indicates a non-linear (S-shaped) rise of the actuator force. The second diagram of FIG. 3 shows the rise of the rotational speed from n₀ to n₁, wherein the rise time T₁ may be shorter than the period of time T_{R}.

In FIG. 4 an example of a method is illustrated that can be implemented with the grinding apparatus described here. First, a grinding machine with a grinding tool (cf. FIG. 1, grinding machine 10, grinding tool 11) is positioned with the aid of a manipulator/robot while the grinding machine is being driven at a first rotational speed (see FIG. 4, step S1). This positioning may involve moving the grinding machine along a previously defined trajectory. During the positioning process, it is determined whether the grinding tool contacts the surface (see FIG. 4, step S2). This can be achieved, for example, by detecting that the deflection of the actuator that is used to control the force (cf. FIG. 1, actuator 20) has changed. Upon determining that contact has taken place, beginning at the first rotational speed, the rotational speed of the motor of the grinding machine, and with it the rotational speed of the grinding tool, is raised (see FIG. 4, step S2).

Terms such as “first”, “second”, and the like, are used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

It is to be understood that the features of the various embodiments described herein may be combined with each other, unless specifically noted otherwise.

Although various embodiments have been illustrated and described with respect to one or more specific implementations, alterations and/or modifications may be made to the illustrated examples without departing from the spirit and scope of the appended claims. With particular regard to the various functions performed by the above described components or structures (units, assemblies, devices, circuits, systems, etc.), the terms (including a reference to a “means”) used to describe such components are intended to correspond unless otherwise indicated to any component or structure that performs the specified function of the described component (e.g., that is functionally equivalent), even if it is not structurally equivalent to the disclosed structure that performs the function in the herein illustrated exemplary implementations of the invention.

It will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1-12. (canceled)

13. A grinding apparatus for machining a surface, the grinding apparatus comprising:
a grinding machine coupled to a manipulator and having a motor and a grinding tool driven by the motor; and
a controller configured to:
control the grinding machine to adjust the rotational speed of the grinding tool;
position the grinding machine by means of the manipulator to contact the surface with the grinding tool while the grinding machine is being driven at a first rotational speed;
detect a contact between the grinding tool and the surface; and
raise the rotational speed of the grinding tool from the first rotational speed to a second rotational speed in response to detecting the contact.

14. The grinding apparatus of claim 13, further comprising:
an actuator configured to adjust a contact force between the grinding tool and the surface,
wherein the controller is configured to detect the contact between the grinding tool and the surface based on a deflection of the actuator or on its change.

15. The grinding apparatus of claim 14, wherein the controller is further configured to increase the contact force between the grinding tool and the surface in response to detecting the contact.

16. The grinding apparatus of claim 13, wherein the controller is further configured to detect a loss of contact and to reduce the rotational speed of the grinding tool in response to detecting the loss of contact.

17. The grinding apparatus of claim 13, wherein the controller is further configured to raise the rotational speed of the grinding tool according to a defined and specifiable progression.

18. The grinding apparatus of claim 13, wherein the manipulator is an industrial robot.

19. A method for automated grinding of surfaces, the method comprising:
robot-supported positioning of a grinding machine that has a grinding tool so that the grinding tool contacts a surface while the grinding machine is being driven at a first rotational speed;
detecting a contact between the grinding tool and the surface; and
increasing the rotational speed of the grinding tool from the first rotational speed to a second rotational speed in response to detecting the contact.

20. The method of claim 19, further comprising:
adjusting the contact force by means of a linear actuator that is disposed between a manipulator and the grinding machine,
wherein the contact between the grinding tool and the surface is detected based on a deflection of the linear actuator or its change.

21. The method of claim 20, wherein in reaction to the detection of the contact, the contact force between the grinding tool and the surface is raised.

22. The method of claim 19, further comprising:
detecting a loss of contact; and
in response to detecting the loss of contact, reducing the rotational speed of the grinding tool.

23. The method of claim 19, wherein the rotational speed of the grinding tool is raised according to a defined and specifiable progression.

24. The method of claim 19, wherein the robot-supported positioning of the grinding machine is carried out by means of an industrial robot.
